(19) United States
(12) Patent Application Publication
(10) Pub. No.: US 2025/0220416 A1
(43) Pub. Date: Jul. 3, 2025

(54) Method for maintaining a secure channel between a client and a server through a wireless network; associated computer program product

(71) Applicants: THALES, Meudon (FR); THALES DIS FRANCE SAS, MEUDON (FR)

(72) Inventors: Franck SCHOLLER, GENNEVILLIERS CEDEX (FR); Joël DEMARTY, MEUDON (FR); Ben Youcef ECH-CHERGUI, CHOLET (FR)

(21) Appl. No.: 19/001,075

(22) Filed: Dec. 24, 2024

(30) Foreign Application Priority Data
Dec. 27, 2023 (FR) 2315345

(51) Int. Cl. H04W 12/03; H04W 12/041; H04W 52/02; H04W 76/19

(52) U.S. Cl. CPC H04W 12/03; H04W 12/041; H04W 52/0229; H04W 76/19

(57) ABSTRACT

A method for maintaining a secure channel between a client and a server through a wireless network, a secret being shared between the client and the server. the method including while the client is in sleep mode and data must be transmitted from the client to the server, wake-up of the client and initiating, by the client, a procedure for restoring the secure channel by transmitting to the server a change of state wake-up message, protected by using the secret, and while the client is in sleep mode and that data must be transmitted from the server to the client, wake-up of the client by the server by means of the transmission of a paging message and launching by the client, the restoring procedure of the secure channel by transmitting to the server, a change of state wake-up message using the secret.

### REFERENCE TO RELATED APPLICATION

This application is a U.S. non-provisional application claiming the benefit of French Patent Application No. 23 15345 filed on Dec. 27, 2023, the contents of which are incorporated herein by reference in their entirety.

### TECHNICAL FIELD OF THE INVENTION

The present invention relates to a method for maintaining a secure channel between a mobile client and a server, through a wireless network.

### BACKGROUND OF THE INVENTION

A Virtual Private Network (VPN) is the establishment of a secure IP tunnel, or VPN tunnel, for the exchange of data between two parties forming the endpoints of the secure channel.

A VPN can be used between two parties, one of which (referred to as a client in the following) is mobile. Same can be a mobile phone connected to a cellular (4G or other) or satellite network, a tablet computer connected to a Wi-Fi network, etc., or, in general, any object connected via an air link to a radiocommunication network.

Mobile use of a VPN means that the context (i.e., VPN tunnel configuration information) of the VPN tunnel endpoints (the VPN client application executed by the client and the VPN server application executed by the VPN server) must be updated as certain client operating parameters change as said client moves, including the client IP address that can be changed when the client attaches to a new base station of the radiocommunication network. It should be noted that the IP address does not necessarily change, and that same depends on the configuration of the operator network and the proximity of the base stations between which the user equipment passes.

Despite such context changes, it would be good not to lose the current VPN session.

Otherwise, the VPN tunnel would have to be reset each time there is a change of context. It would then be necessary to resume the authentication procedures (by login and password) of application sessions passing over the VPN channel between an application running on the client and a service server.

Thereof is not possible, e.g., when the client is used on-board a train and is likely to frequently change the IP address of said client.

The use of a VPN across non-wired networks thus requires the implementation of persistence mechanisms to ensure continuity of services between a VPN client and the VPN server—also called a VPN gateway—establishing the virtual private network.

The mechanisms must guarantee continuity of service in both directions, i.e., for outgoing traffic and incoming traffic (with respect to the client), while retaining mobility functionalities (roaming between cells of the same network (“handover”) or cells of different networks (“roaming”) in the case of cellular networks).

In particular, the mechanisms provided for by different recommendations “Requests for comments” (RFC) of the IETF (“Internet Engineering Task Force”) consist in exchanging a sign-of-life signal (“heart beat”) between the VPN client application and the VPN server application, in order to guarantee and confirm the integrity of the virtual channel—or VPN tunnel—mounted between the client and the VPN server and to respond to problems related to the mobility of the client running the embedded VPN client application.

Reception of the heartbeat signal by one endpoint of the VPN tunnel, by the other endpoint of that same VPN tunnel makes it possible to always keep the VPN tunnel “on” or “open”. Thereby, the exchange of signaling data along the VPN tunnel ensures the desired continuity of service.

In particular, while the client is placed in “sleep” mode, also known as “idle mode”, the VPN client application always keeps the VPN tunnel open.

However, thereof implies maintaining signaling data communication on the air interface, even if no application datum circulates.

The client thus generates constant noise on the user plane. Same is not silent, even when in sleep mode and does not transfer any application datum.

Moreover, remaining in sleep mode imposes constant use of the client's means of communication and, consequently, a high energy consumption, even while the client is in “sleep” mode. The client's batteries are quickly depleted.

### SUMMARY OF THE INVENTION

The goal of the invention is thereby to propose a method for maintaining a VPN tunnel by offering secure mechanisms for ensuring the continuity of service associated with the use of a VPN tunnel in mobility, without having to exchange service messages to keep the VPN tunnel “open” while the client is in “sleep” mode.

To this end, an aspect of the invention is a method for maintaining a secure channel between a client and a server through a non-wired network, the method including the steps of a secret being shared between the client and the server: while the client is in “sleep” mode and data must be transmitted from the client to the server, client wake-up and initiating, by the client, of a procedure for restoring the secure channel by transmitting to the server, a “wake-up” message of change of state protected by using said secret; and while said client is in “sleep” mode and that data must be transmitted from the server to the client, wake-up of the client by the server by means of the issuing of a message from the radio messaging service and launch by the client of the re-establishing procedure of the secure channel by transmitting to the server, a “wake-up” message of change of state protected by using said secret.

According to other advantageous aspects of the invention, the method includes one or a plurality of the following features, taken individually or according to all technically possible combinations:
the method further includes a step of exchanging the secret consisting, in “connected” mode and while the secure channel is established, in calculating, as secret, a reference key by an agent among the client and the server, and in transmitting, via the secure channel, the secure key to the other agent;
the reference key Kref is generated from an identifier of the current session between the client and the server along the secure channel;
an AES 256 algorithm is executed to calculate the reference key;
the server maintaining a server context of the secure channel and the client maintaining a client context of the secure channel, the procedure for restoring the secure channel consists in: adapting, by the client, the client context with a plurality of modified information items including at least one current IP address of the client, transmitting, by the client to the server, the plurality of modified information items in the wake-up message of change of state, and, by the server, adapting, by the server, the context associated with the reference key, according to the plurality of information items received;
the secure channel is a VPN channel, the client running a VPN client application and the server running a VPN server application;
a “stand-by” message of change of state is transmitted by the client to the server, said standby message being protected by the secret shared between the client and the server;
a message of change of state contains: the client identifier, an anti-replay counter, the “sleep” or “wake-up” message of change of state, and all or part of the updated client context for a “wake-up” message of change 20 of state;
while client and/or server contexts have not been saved before switching the client to the “sleep” mode, following the transmission to the server of a “wake-up” message of change of state, the client initiates a key negotiation to establish the secure channel.

Another aspect of the invention is a computer program including software instructions which, when executed by the computer of a client or server communicating via a secure channel through a wireless network, implement a method according to the preceding method.

### BRIEF DESCRIPTION OF THE DRAWINGS

The invention will be better understood upon reading the following description, given only as an example, but not limited to, and making reference to the drawings wherein:

FIG. 1 is a schematic representation of an infrastructure using a VPN; and

FIG. 2 is a schematic representation of a method according to the invention.

### DETAILED DESCRIPTION OF THE INVENTION

In general, the VPN tunnel wake-up mechanism of the method according to the invention is based on the sharing, between the VPN client application and the VPN server application, of a reference key exchanged while the VPN channel is “open”. The reference key serves to validate a future request for data exchange between the two parties via the VPN channel, while the latter is “closed”.

A VPN channel is called “open” when each party has the VPN keys and context settings for said VPN channel. Henceforth, closing a VPN channel amounts to no longer being able to decrypt the flows transmitted in said VPN channel, i.e., no longer having either VPN keys or context information (or both).

To re-establish the communication, the invention makes it possible to switch from the “closed” state to the “open” state securely, in particular by validating that there is no “man in the middle attack” capable of using captured context information to re-establish the channel.

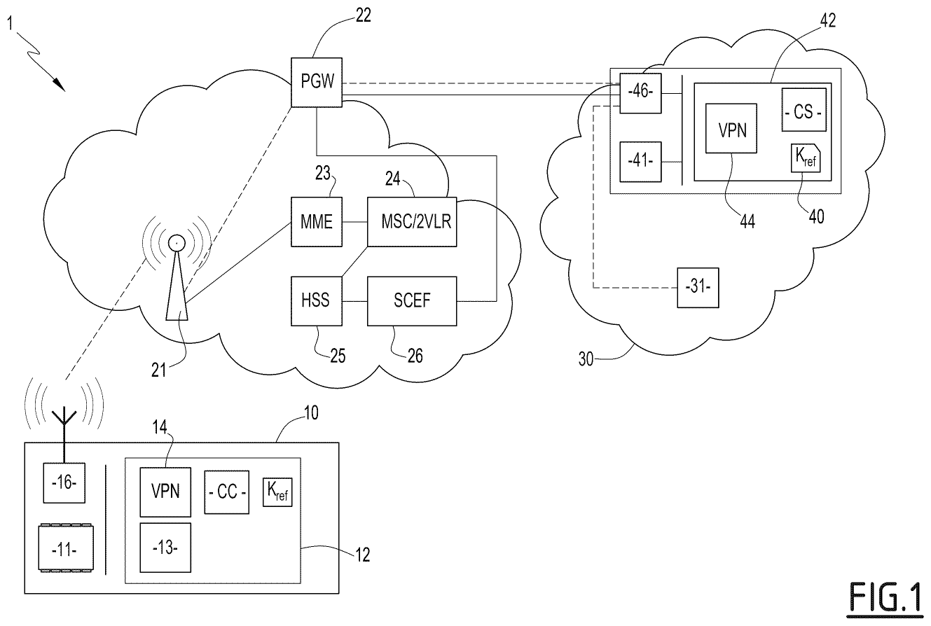

With reference to FIG. 1, an embodiment of a computer infrastructure the implementation of the method according to the invention will be presented.

The FIG. 1 infrastructure includes a client 10, such as a mobile phone.

The client 10 is a computer 14 including means of computing such as a processor, and means of storage 12, such as a memory. The memory stores in particular the instructions of computer programs, in particular a program the execution of makes possible the implementation of a service application and a program, the execution of which makes possible the implementation of a VPN client application 14.

The memory 12 also stores a reference key Kref and a client context CC.

The client 10 includes a radio-communication module 16.

The infrastructure 1 includes a radio-communication network 20.

The network 20 includes base stations, such as station 21.

The network 20 includes a PGW (Packet Data Network Gateway) 22 for connection to a public network 30.

For example, for an implementation conforming to the fourth generation—4 G, the network 20 includes, in a known manner, a mobility management entity (MME) 23, a mobile switching center/visitor location register (MSC/VLR) 24, a Home Subscriber Server (HSS) 25 and a Service Capability Exposure Function (SCEF) 26.

The public network 30 includes a service server 31.

The public network 30 includes a VPN server 40.

The VPN server 40 including means of calculating such as a processor 41, and means of storage 42, such as a memory. The memory in particular stores the instructions of computer programs, in particular a program the execution of which serves to implement the method according to the invention.

The memory 42 also stores a reference key Kref and a server context CS.

The VPN server 40 includes an input/output interface 46.

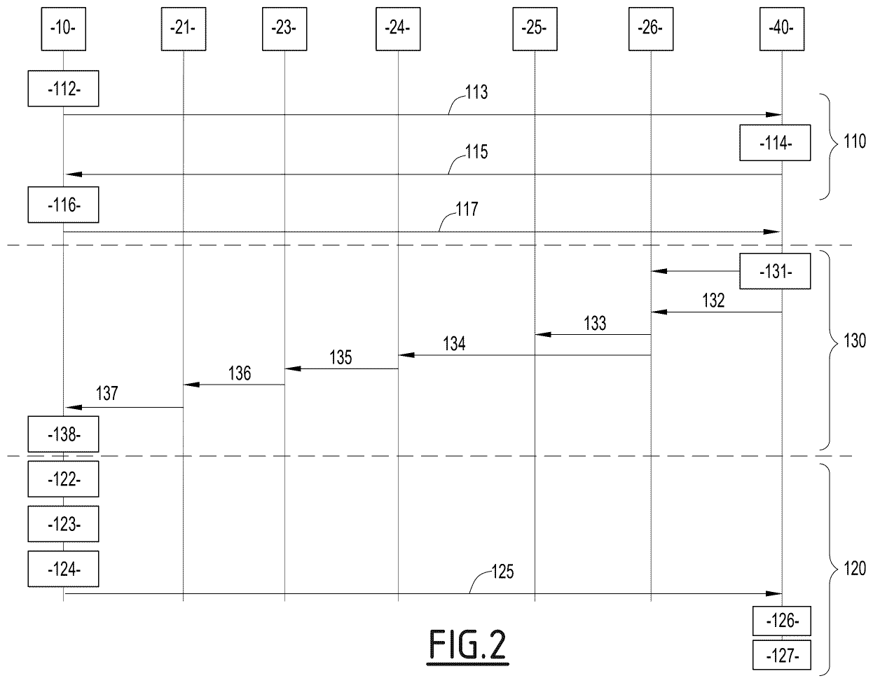

With reference to FIG. 2, a preferred embodiment of the method according to the invention will be presented.

The method 100 includes a reference key generation phase 110, a wakeup phase upon request from the VPN client 120 and a wakeup phase upon request from the VPN server 130.

### Phase 110 of Generation of a Reference Key

In the “connected” mode of the client 10, a VPN tunnel is established between the two endpoints, the VPN client application 14 running on the mobile client, and the VPN server application 44 running on the VPN server 40.

Thereof allows the application 13 to access the service server 31 through the VPN tunnel and the VPN server 40.

The VPN client application 14 stores a set of VPN tunnel attributes gathered in the CC client context.

The VPN server application 44 also stores a set of attributes of the VPN tunnel, gathered in a CS server context.

During a VPN communication session, data messages are exchanged between the VPN client application 14 and the VPN server application 44 along the VPN tunnel.

Each message contains a VPN session ID. The identifier is incremented with each message exchanged. The incrementation is consistent between the VPN server application and the VPN client application.

The VPN session ID is part of the client and server contexts.

Either a secret is already shared between the mobile terminal 10 and the VPN server 40 (like a certified public key) and step 110 is summarized in step 117, or no secret is yet shared between the mobile terminal 10 and the VPN server 40 and step 110 includes steps 112 to 116 of sharing a reference key as secret.

Thereby, in the latter case, before the client 10 switches to the “sleep” mode, the VPN client application 14 generates (step 112) a reference encryption key, Kref.

For example, an AES 256 (“Advanced Encryption Standard”) algorithm is executed by the VPN client.

Advantageously, the reference key Kref is derived from the current value of the VPN session identifier, i.e., the identifier of the last VPN session that received a positive response from the VPN server application.

The VPN client application 14 transmits (step 113), via the VPN channel, an information message to the VPN server application 44, the information message including the reference key Kref generated in step 112.

When the information message is received, the VPN server application stores (step 114) the reference key, Kref, in association with the current server context of the VPN tunnel.

The VPN server confirms the correct reception of the reference key by transmitting (step 115) an acknowledgment message to the VPN client application.

Upon receipt of the control message, the VPN client application 14 stores (step 116) the reference key Kref in association with the current client context of the VPN tunnel.

In a variant, it is the VPN server application that generates the reference key and passes said key to the VPN client application through the VPN tunnel. The latter sends back an acknowledgment message of the reference key.

Then, during step 117, a standby message is then transmitted by the mobile terminal 10 to the VPN server 40. Such message of change of state is protected, by encryption, with the secret shared between the two parties, such as the reference key Kref.

The message of change of state of the mobile terminal contains: the identifier of the mobile terminal, an anti-replay counter for countering replay attacks, the “standby” or “wake-up” information, and, optionally, the context information of the VPN if the information has changed during the sleep phase of the mobile terminal (in particular the IP address of the mobile terminal).

The client 10 then switches to “sleep” mode and the VPN tunnel is temporarily “closed”.

No datum is then exchanged between the VPN client application and the VPN server application.

The method 100 has the capability of resumption, at the request of one or other of the two parties.

To this end, the VPN client application 14 and the VPN server application 44 must be constantly open, waiting for a wake-up message to be received from the other party.

### Wake-Up Phase 120 Triggered by the VPN Client Application

In the event that data must be transmitted from the client, the client switches (step 122) from the “sleep” mode to the “connected” mode and requests the VPN client application 14 to re-establish the VPN tunnel.

The VPN client application 14 must then rebuild the VPN tunnel while maintaining continuity of service.

For this, it is possible to implement a mechanism derived from the so-called “Auto reconnect” mechanism, as defined in the RFC 5723 standard.

During a step 123, the VPN client application 14 extracts from the memory thereof the reference key Kref and the associated client context CS, corresponding to the client context before the interruption.

During a step 124, the client application VPN updates the client context CS with the information that has changed during the sleep phase, in particular the IP address of the terminal.

During a step 125, a wake-up message is sent by the terminal 10 to the VPN server 40. The message of change of state is protected, by encryption, with the secret shared between the two parties, such as the reference key Kref.

The optional part of the message of change of state includes the VPN context information that has changed during the sleep phase of the mobile terminal (including the IP address of the mobile terminal).

Upon reception of the VPN tunnel restoration message, the VPN server application 44 decrypts (step 126) the message of change of state using the shared secret and extracts the operational information. The cryptographic verification of the message validates integrity and authenticity thereof.

Advantageously, the VPN application 44 also checks the validity of the anti-replay counter, to detect if the wake-up message is not a replay.

If the checks lead to errors, the message is deleted.

Otherwise, during a step 127, the VPN server application 44 possibly transmits, if appropriate, a confirmation that the message has been received, but above all updates the server context CS with the information received in the message of change of state.

The VPN server application 44 thereby restores the VPN tunnel previously set up before the standby, without requiring negotiation between the parties (including new VPN encryption keys).

Hence a faster commissioning of the VPN tunnel at the wake-up.

Thereby, both parties have updated contexts allowing the parties to resume the VPN communication session where said communication session stopped. Secure messages can then be transmitted.

In some use cases, the ability to put a terminal in “sleep” mode so that said terminal is silent is more important than keeping the VPN context. In such case, the mobile terminal goes into “standby” mode, deletes the VPN context thereof (the server also deletes the VPN context on the server side) and, at the moment when a wake-up is requested (either by the terminal or by the server), the terminal initiates a new negotiation of VPN keys to establish a new VPN context.

What is kept in memory by the server and the terminal during a standby phase is the protection secret (in particular the reference key) of the standby/wake-up messages and, advantageously, the anti-replay counter, which is unique between each mobile terminal/VPN server pair.

### Wake-Up Phase 130 Triggered by the VPN Server Application

In the event that data needs to be transmitted from the server to the client, the client must be able to be informed to switch from “sleep” mode to “connected” mode and to ask the VPN client application to initiate the VPN tunnel recovery procedure (phase 120).

To this end, a paging mechanism is implemented for the transmission of a wake-up message from the VPN server application to the client.

The wake-up message includes all or part of the context information CS from the server.

During step 138, once awakened, the terminal updates the context CS thereof. If there is a discrepancy between the updated context CC of the terminal and the context information CS communicated by the server, the terminal 10 initiates the procedure of phase 120 so that the VPN client application and the VPN server application reconstruct the VPN tunnel by updating the contexts before the interruption with the roaming information of the client, and thereby ensure the continuity of the VPN communication by continuing the VPN session.

Henceforth, the VPN context is active and operational again.

In the case where the context was not stored prior to sleep, the wake-up message does not contain context information on the VPN server side. Phase 120 then includes a negotiation of VPN keys to establish a new VPN context.

In a preferred embodiment, the paging mechanism for transmitting a wake-up message from the server to the client derives from the procedure, presented in the ETSI technical recommendation TS 29 337 V11.7.0 (2016 January), allowing a connected object-IoT (“Internet of Things”) to respond to a request from a client portal (SCS).

Thereby, in order for the VPN server application 44 to be able to use the paging functionality, it must first be registered (step 131) with the entity SCEF (or MTC-IWF) 26, in order to obtain the right to send wakeup messages by paging.

The purpose of the record is to create a transaction identifier and the query rights thereby forming an entry in the context table of the SCEF entity, to which is added the identifier of the client to be woken up.

The client can be identified from the MSISDN number thereof, an external identifier saved on an MTC AAA authentication server of the operator, or a group identifier.

To wake up the client, the VPN application 44 first contacts (step 132) the SCEF entity 26 via a DIAMETER request. The DIAMETER request includes the public identity of the client and the reference key Kref.

When the entity SCEF receives a wake-up request, it first contacts (step 133) the HSS (or the HLR) database 25 in order to convert the public identity of the client into an identity internal to the operator network (IMSI identifier).

Optionally, the HSS/HLR 25 entity can contact an authentication server to convert an external identity to an IMSI number.

If the client identity is recognized, the SCEF entity retrieves the client's subscription information to connect the VPN application to the client.

The SCEF 26 entity defines the most appropriate wake-up method on the control plan to trigger a client action, based on the following information:
Current client accessibility information (on which network the client is located, and on which area);
Methods for triggering service supported by the HPLMN or VPLMN network;
Trigger methods supported by the client;
The operator's wake-up trigger policies;
Other information received from the VPN server application including potentially the location of the client if known. Localization optimizes the paging to the cell and not to the localization area—TAI (Tracking Area Identifier) which groups together a large number of cells.

Possible wake-up methods are:
MT SMS: the client has to be able to recognize in the wake-up message an MT SMS from the VPN server application;
Cell Broadcast: the cell Broadcast procedure is used to wake up the client by sending information about SIBs carried by the beacon channel;
NAS signaling;
IMS messages.

The SCEF 26 then sends (step 134) a wake-up message to the MSC 24, which forwards said message (step 135) in turn to the MME 23, which forwards said message (step 136) in turn to the base station 21, which broadcasts said message (step 137) in the cell where the client is located.

The client 10 listening to the radio environment thereof, receives the wake-up message. Said client compares (step 138) the reference key indicated in this wake-up message with the reference key Kref that said client stores.

In the event of correlation, the client 10 switches (step 122) from the “sleep” mode to the “connected” mode and initiates the VPN tunnel re-establishment procedure. Steps 121 to 127 are performed to reopen the VPN tunnel.

### ADVANTAGES

With this automated mechanism for reconstructing the VPN tunnel between a mobile client and a VPN server, the method according to the invention guarantees continuity of service after a period of silence. The automated mechanism makes it possible to restore all security means instantly without loss of service or the need to restore authentication (costly in time and operations).

It should be noted that the wakeup message broadcast on a cell is intercepted by all the terminals on that cell. With the mechanism according to the invention, the only terminal effectively awakened is the one capable of validating all the keys present in the message. There is thus no abusive wake-up of the terminals, but only the terminal concerned is woken up.

The method according to the invention offers a mechanism allowing a client to remain silent when the latter does not transmit or receive any application data, since no persistent communication channel is maintained when there is no application data communication. More particularly, the method avoids the exchange of a heartbeat signal.

The method offers both a VPN tunnel establishment mechanism and a mobile client sleep mechanism that does not signal the existence of the VPN tunnel.

Said method increases the security of the VPN tunnel between the client and the VPN server.

1. A method of maintaining a secure channel between a client and a server over a wireless network, a secret being shared between the client and the server, the method comprising:
while the client is in a sleep mode and data is to be transmitted from the client to the server:
waking-up the client; and
launching, by the client, a secure channel re-establishment procedure comprising transmitting to the server a wake-up message of change of state, the wake-up message being protected using the secret; and
while the client is in a sleep mode and a data is to be transmitted from the server to the client:
waking-up the client by the server comprising sending a paging message; and
initiating by the client a procedure for restoring the secure channel comprising transmitting to the server a wake-up message of change of state, the wake-up message being protected using the secret.

2. The method according to claim 1, further comprising exchanging the secret comprising, in a connected mode and while the secure channel is established:
calculating a reference key by an agent among the client and the server; and
transmitting, via the secure channel, the secure key to the other agent, the secure key being the secret.

3. The method according to claim 2, further comprising generating the reference key from an identifier of a current session between the client and the server along the secure channel.

4. The method according to claim 2, further comprising executing an AES 256 algorithm to calculate the reference key.

5. The method according to claim 1, wherein the wake-up message of change of state comprises an identifier of the client, an anti-replay counter, and a type wake-up.

6. The method according to claim 1, wherein the server maintains a server context of the secure channel and the client maintains a client context of the secure channel, and wherein said initiating comprises:
adapting, by the client, the client context with a plurality of modified information items comprising at least one current IP address of the client;
transmitting, by the client to the server, the plurality of modified information items in the wake-up message; and
adapting, by the server, the server context associated with the reference key, as a function of the plurality of information items received.

7. The method according to claim 6, wherein the wake-up message of change of state comprises an identifier of the client, an anti-replay counter, a type wake-up, and all or part of a client context updated for a message of change of state of the wake-up type.

8. The method according to claim 1, wherein the secure channel comprises a VPN channel, the client running a VPN client application and the server running a VPN server application.

9. The method according to claim 1, further comprising transmitting a sleep message of change of state by the client to the server, the sleep message being protected by the secret shared between the client and the server.

10. The method according to claim 9, wherein the sleep message of change of state comprises an identifier of the client, an anti-replay counter, and a type sleep.

11. The method according to claim 1, further comprising, while client and/or server contexts have not been saved before switching the client to sleep mode, following said transmitting, initiating by the client a key negotiation to establish the secure channel.

12. A computer program comprising software instructions which, when executed by the computer of a client or server communicating via a secure channel through a wireless network, implement a method according to claim 1.
